(19) United States
(12) Patent Application Publication
(10) Pub. No.: US 2026/0208374 A1
(43) Pub. Date: Jul. 23, 2026

(54) SPECIAL EQUIPMENT SAFETY SUPERVISION INSPECTION INSTITUTE OF JIANGSU PROVINCE

(71) Applicants: SPECIAL EQUIPMENT SAFETY SUPERVISION INSPECTION INSTITUTE OF JIANGSU PROVINCE, Nanjing, Jiangsu (CN); NANJING INSTITUTE OF TECHNOLOGY, Nanjing (CN)

(72) Inventors: Chunlei TU, Nanjing (CN); Donghua SHEN, Nanjing (CN); Yonghua GU, Nanjing (CN); Rou CHENG, Nanjing (CN); Jie LI, Nanjing (CN)

(21) Appl. No.: 18/730,691

(22) PCT Filed: Jun. 18, 2024
(86) PCT No.: PCT/CN2024/099727

§ 371 Date: Jul. 19, 2024

(30) Foreign Application Priority Data
Jun. 17, 2024 (CN) 202410777521.1

(51) Int. Cl. B25J 17/02; B25J 9/14

(52) U.S. Cl. CPC B25J 17/0275; B25J 9/142

(57) ABSTRACT

The present invention discloses a variable-rigidity continuum robot, relating to the technical field of soft robotics. The present invention includes a driving seat, a first central hole is opened at a center of the driving seat, and a spring chuck is mounted inside the first central hole. A driving unit is disposed on a sidewall of the driving seat, a ball and socket unit is deflectably connected to the driving unit, a steering ball unit is rotatably connected to the other side of the ball and socket unit, and the steering ball unit and the ball and socket unit are alternately arranged. An end of the ball and socket unit is rotatably connected to an end seat unit, and an elastic rod penetrates the steering ball unit and the ball and socket unit. In the present invention, structures of an inner friction layer, an intermediate friction layer, and an outer friction layer are disposed, a membrane balloon is inflated to expand to compress the friction layers, and a frictional force between adjacent units increases under the action of friction, so that adjacent units connected in series have a very large friction locking torque, and the bending rigidity of the entire continuum robot can be changed to a large extent.

### TECHNICAL FIELD

The present invention relates to the technical field of soft robotics, specifically to a variable-rigidity continuum robot.

### BACKGROUND

A large number of thermal containers, pipelines (of long-distance, industrial, and gas types) and other narrow equipment spaces, furnace inner walls, pressure containers (heat exchangers and packaged apparatuses), small-tube diameter equipment exist in energy and petrochemical pressure equipment, it is difficult to implement efficient and reliable automated non-destructive inspection and flaw detection maintenance, and a potential safety hazard is prone to a detection miss to cause a catastrophic accident. Therefore, to implement efficient and reliable intelligent non-destructive inspection and flaw detection maintenance in a dangerous and special narrow space environment has become a hotspot and a difficulty in the industry.

To resolve the foregoing problems, a continuum robot is often used to perform a non-destructive flaw inspection in the prior art. Due to its bendability, the continuum robot may continuously deform to adapt to a contact object and significantly reduce a contact stress, and therefore has higher compliance, safety, and adaptability and has unique advantages in aspects such as minimally invasive procedures, disaster search and rescue, grasping of fragile objects, and operation in a narrow space and a multi-obstacle environment. However, the continuum robot usually has low rigidity and as a result has a poor bearing capability. Although a variable-rigidity structure represented by a jamming structure has resolved to some extent the problem of low rigidity of a continuum robot, problems such as a limited change range of rigidity and a slow change of rigidity still exist. For this, a variable-rigidity continuum robot is proposed.

### SUMMARY

An objective of the present invention is to provide a variable-rigidity continuum robot, so that friction locking of adjacent units can be implemented through a balloon compressing friction layers, thereby changing the bending rigidity of the robot and improving the bearing capability of the robot.

To achieve the foregoing objective, the present invention provides the following technical solution. A variable-rigidity continuum robot includes a driving seat, where a first central hole is opened at a center of the driving seat, a spring chuck is mounted inside the first central hole, a tapered portion is disposed at a top of the spring chuck, a notch is opened in a sidewall of the tapered portion, and a first tapered surface matching the tapered portion is disposed on an inner sidewall of the first central hole close to a bottom;
an end of the spring chuck away from the tapered portion extends out of an end portion of the driving seat and is threadedly connected to a locking nut;
an elastic rod is detachably mounted on the spring chuck, a driving unit is disposed on a sidewall of the driving seat, a ball and socket unit is deflectably connected to the driving unit, a steering ball unit is rotatably connected to the other side of the ball and socket unit, both a plurality of steering ball units and a plurality of ball and socket units are disposed, and the steering ball units and the ball and socket units are alternately arranged;
an end of the ball and socket unit is rotatably connected to an end seat unit, the elastic rod penetrates the steering ball unit and the ball and socket unit, and a tail end of the elastic rod is detachably mounted on the end seat unit; and
a plurality of driving ropes are fixedly connected to the end seat unit, the plurality of driving ropes are generally arranged in a circumferential direction, and all the plurality of driving ropes penetrate the steering ball unit, the ball and socket unit, the driving unit, and the driving seat.

Further, the driving unit includes a first cylindrical body fixedly connected to a central position of the driving seat, the first cylindrical body is hollow inside and is in communication with the first central hole, and the elastic rod is arranged penetrating the first cylindrical body and the first central hole;
a membrane balloon assembly is sleeved over an outer surface of the first cylindrical body, t he outer surface of the first cylindrical body is slidably connected to a movable plate, and the membrane balloon assembly is located between the movable plate and the driving seat;
a first dome protrusion is disposed on an outer side of the movable plate, an inner friction layer and an outer friction layer are fixedly connected to a sidewall of the movable plate, the inner friction layer is located between the outer friction layer and the first dome protrusion, the inner friction layer and the outer friction layer are both disposed in a spherical shape, and spherical centers of the inner friction layer, the outer friction layer, and the first dome protrusion coincide; and
an inner unloading groove is opened in a sidewall of the inner friction layer, an outer unloading groove is opened in a sidewall of the outer friction layer, a cross spherical ring is slidably connected to the sidewall of the outer friction layer, an inner slider is fixedly connected to an inner spherical surface of the cross spherical ring, an outer slider is fixedly connected to an outer spherical surface, the cross spherical ring is joined to an outer surface of the outer friction layer, and an outer-layer sliding slot matching the inner slider is opened in an outer sidewall of the outer friction layer.

Further, the membrane balloon assembly is formed by superimposing a plurality of membrane balloons and is generally disposed in a bellows shape, an air hole is opened inside each of the plurality of membrane balloons, adjacent membrane balloons are in communication with each other through the air holes, an air pipe is mounted penetrating the sidewall of the driving seat, and the air pipe is connected to and in communication with the air holes.

Further, the ball and socket unit includes a double ball and socket sleeve, a ball socket is opened at each of two ends of the double ball and socket sleeve, and a ball socket slot is provided inside the ball socket;
a second central hole is opened at a central position of the double ball and socket sleeve, two guide rings are symmetrically disposed at two ends of the second central hole, both inner and outer surfaces of each guide ring are concentric spherical surfaces, and the two guide rings are respectively concentric with the ball sockets at the two ends of the double ball and socket sleeve;
a second cylindrical body is fixedly connected to a sidewall of the guide ring, the second cylindrical body is mounted in the second central hole, the second cylindrical body is hollow inside, the second cylindrical body and the guide ring are in communication, and the elastic rod penetrates the second cylindrical body and the second central hole; and
an intermediate friction layer is disposed between the ball socket opened at each of the two ends of the double ball and socket sleeve and the guide ring, both inner and outer surfaces of the intermediate friction layer are concentric spherical surfaces, the intermediate friction layer is concentric with the ball socket, and the intermediate friction layer is sleeved over the second cylindrical body.

Further, when the driving unit is rotatably connected to the ball and socket unit, the first dome protrusion on an end surface of the movable plate, the guide ring, the inner friction layer, the intermediate friction layer, the outer friction layer, and the cross spherical ring are sequentially connected and concentrically arranged; and
the outer slider on an outer side of the cross spherical ring in the driving unit is inserted in the ball socket slot of the double ball and socket sleeve and slides along the ball socket slot.

Further, the steering ball unit includes a joint ball, two second dome protrusions are disposed on two sides of the joint ball, the two second dome protrusions are concentric, a guide hole is opened at a top end of each of the two second dome protrusions, and the elastic rod penetrates the guide holes of the joint ball;
the inner friction layer and the outer friction layer are respectively fixedly connected to the two sides of the joint ball, the inner friction layer is located between the outer friction layer and the second dome protrusion, and the inner friction layer, the outer friction layer, and the second dome protrusion are concentrically arranged; and
the cross spherical ring is also slidably connected to the outer sidewall of the outer friction layer.

Further, when the steering ball unit is rotatably connected to an adjacent ball and socket unit, the second dome protrusion on the joint ball, the guide ring, the inner friction layer, the intermediate friction layer, the outer friction layer, and the cross spherical ring are sequentially connected and concentrically arranged; and
the outer slider on the outer side of the cross spherical ring in the steering ball unit is inserted in the ball socket slot of the double ball and socket sleeve and is slidable along the ball socket slot.

Further, the end seat unit includes an end plate fixed at an end of each driving rope, an end dome is fixedly connected to a sidewall of the end plate, a third central hole is opened at central positions of the end plate and the end dome, the spring chuck is mounted in the third central hole, a second tapered surface matching the tapered portion of the spring chuck is disposed in the third central hole, and the tail end of the elastic rod is connected in the spring chuck;
the end of the spring chuck away from the tapered portion is threadedly connected to the locking nut, and the locking nut is located in the third central hole of the end dome;
the inner friction layer and the outer friction layer are fixedly connected to the sidewall of the end plate, the inner friction layer is located between the outer friction layer and the end dome, and the inner friction layer, the outer friction layer, and the end dome are concentrically arranged; and
the cross spherical ring is also slidably connected to the outer sidewall of the outer friction layer.

Further, when the end seat unit is rotatably connected to an adjacent ball and socket unit, the end dome, the guide ring, the inner friction layer, the intermediate friction layer, the outer friction layer, and the cross spherical ring are sequentially connected and concentrically arranged; and
the outer slider on the outer side of the cross spherical ring in the end seat unit is inserted in the ball socket slot of the double ball and socket sleeve and is slidable along the ball socket slot.

Further, a pin hole is opened in the driving seat, a rotation-limiting pin is fixedly connected in the pin hole, and the other end of the rotation-limiting pin is slidably connected in the movable plate.

The present invention at least has the following beneficial effects.
1. In the present invention, the cross spherical ring is added between adjacent units connected in series, the inner slider and the outer slider are respectively disposed on the inner and outer spherical surfaces of the cross spherical ring, and the two sliders are perpendicular to each other in a projection plane. Two groups of sliders fit the outer-layer sliding slot and the ball socket slot, the torsion between adjacent units connected in series is restricted, and the freedom of torsion of the entire continuum robot is restricted. Therefore, the robot has a very high torsional rigidity.
2. In the present invention, the structures of the inner friction layer, the intermediate friction layer, and the outer friction layer are disposed, the membrane balloon is inflated to expand to compress the friction layers, and a frictional force between adjacent units increases under the action of friction, so that adjacent units connected in series have a very large friction locking torque, and the bending rigidity of the entire continuum robot can be changed to a large extent.
3. In the present invention, the plurality of membrane balloons are superimposed to compress the friction layers. Because each membrane balloon has a small internal space and a large cross-sectional area, the inflation and deflation speeds of the balloon are fast. Compared with existing balloons in which structural rigidity is changed in a particle filling manner, the continuum robot in the present invention has a rigidity variability in a larger range and has a very high change speed of rigidity.

Certainly, any product implementing the present invention does not necessarily need to have all the foregoing advantages.

### BRIEF DESCRIPTION OF THE DRAWINGS

FIG. 1 is a schematic cross-sectional view of an overall structure according to the present invention;

FIG. 2 is a schematic cross-sectional view of a structure of a driving unit according to the present invention;

FIG. 3 is a schematic cross-sectional view along A-A of a structure of a driving unit according to the present invention;

FIG. 4 is a three-dimensional schematic diagram of a membrane balloon assembly according to the present invention;

FIG. 5 is a three-dimensional schematic diagram of a structure of an inner friction layer according to the present invention;

FIG. 6 is a three-dimensional schematic diagram of a structure of an outer friction layer according to the present invention;

FIG. 7 is a three-dimensional schematic diagram of a structure of a cross spherical ring according to the present invention;

FIG. 8 is a schematic cross-sectional view of a ball and socket unit according to the present invention;

FIG. 9 is a three-dimensional schematic diagram of a structure of a double ball and socket sleeve according to the present invention;

FIG. 10 is a schematic cross-sectional view of a steering ball unit according to the present invention;

FIG. 11 is a schematic cross-sectional view of an end seat unit according to the present invention; and

FIG. 12 is a three-dimensional schematic diagram of an overall structure according to the present invention.

### REFERENCE NUMERALS

1. driving seat; 11. driving unit; 111. first tapered surface; 112. through hole; 113. first central hole; 114. first cylindrical body; 12. spring chuck; 121. notch; 122. tapered portion; 13. locking nut; 14. membrane balloon assembly; 141. membrane balloon; 1411. air hole; 15. movable plate; 151. first dome protrusion; 16. inner friction layer; 161. inner-layer protrusion; 162. inner unloading groove; 17. outer friction layer; 171. outer-layer sliding slot; 172. outer unloading groove; 173. outer-layer protrusion; 18. cross spherical ring; 181. inner slider; 182. outer slider; 19. rotation-limiting pin; 20. air pipe; 2. elastic rod; 3. driving rope; 4. ball and socket unit; 41. double ball and socket sleeve; 411. ball socket; 412. ball socket slot; 413. second central hole; 42. intermediate friction layer; 43. guide ring; 44. second cylindrical body; 5. steering ball unit; 51. joint ball; 511. second dome protrusion; 512. guide hole; 6. end seat unit; 61. end plate; 611. third central hole; 612. second tapered surface; and 62. end dome.

### DETAILED DESCRIPTION

The following clearly and completely describes the technical solutions in the embodiments of the present disclosure with reference to the accompanying drawings in the embodiments of the present disclosure. The described embodiments are some exemplary embodiments of the present disclosure and not to be taken in an exhaustive sense. All other embodiments obtained by a person of ordinary skill in the art based on the embodiments of the present disclosure without creative efforts shall fall within the scope of the present disclosure.

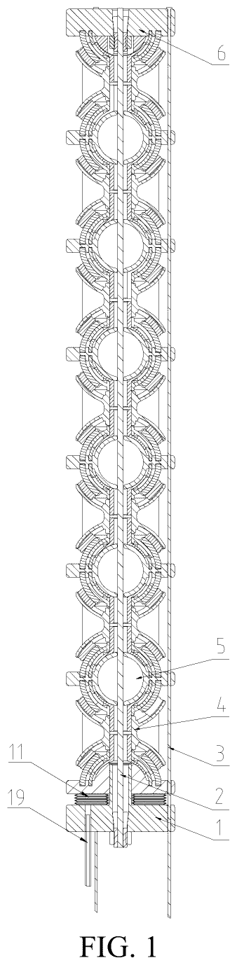

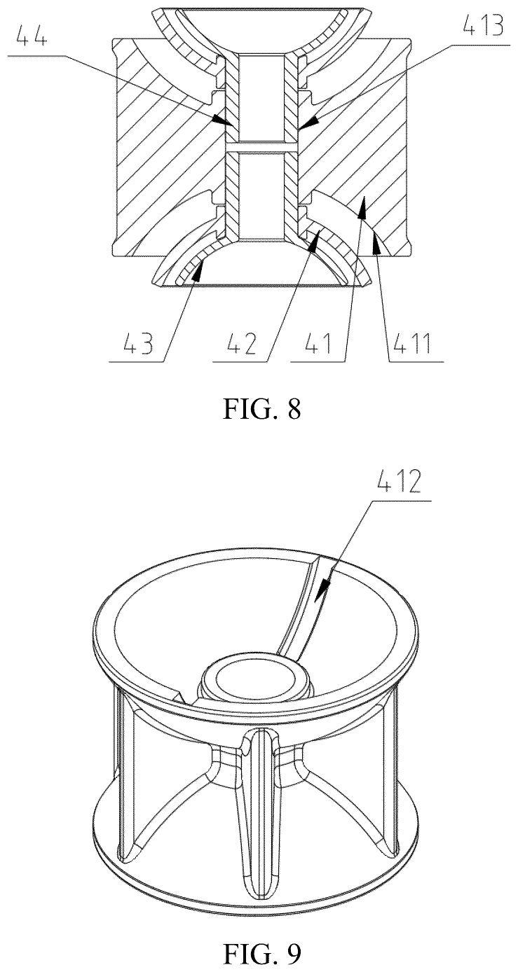

Referring to FIG. 1 to FIG. 12, the present invention provides a technical solution: A variable-rigidity continuum robot includes a driving seat 1. A first central hole 113 is opened at a center of the driving seat 1. A spring chuck 12 is mounted inside the first central hole 113. A tapered portion 122 is disposed at a top of the spring chuck 12. A first tapered surface 111 matching the tapered portion 122 is disposed on an inner sidewall of the first central hole 113 close to a bottom.

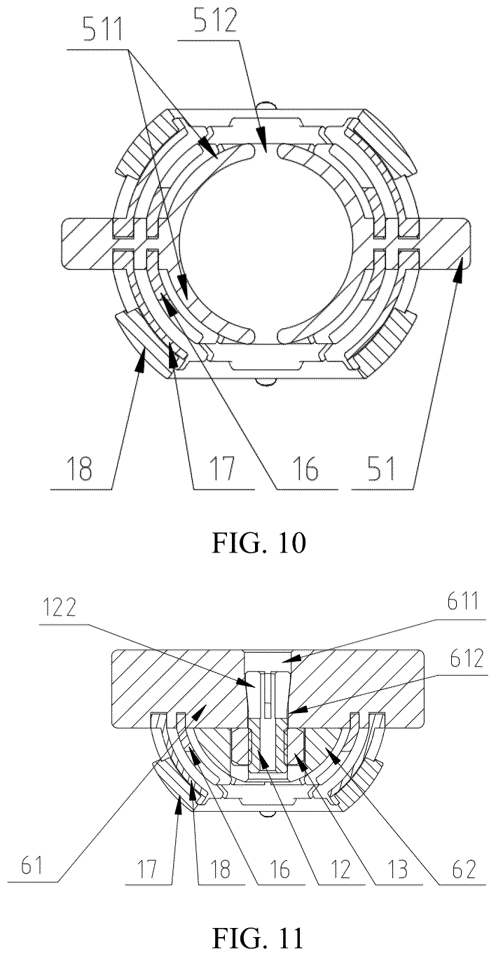

As shown in FIG. 3, an elastic rod 2 is detachably mounted on the spring chuck 12. An end of the spring chuck 12 away from the tapered portion 122 extends out of an end portion of the driving seat 1 and is threadedly connected to a locking nut 13. A through hole 112 is provided at a center of the spring chuck 12. A notch 121 is opened in a sidewall of the tapered portion 122. Therefore, the locking nut 13 is rotated to drive the tapered portion 122 to compress the first tapered surface 111. Under the constraint of the first tapered surface 111, a conical portion of the spring chuck 12 may have a slight elastic deformation to gradually reduce the notch 121, so that the elastic rod 2 in the through hole 112 at the center of the spring chuck 12 can be clamped. The disposed elastic rod 2 can mainly implement a connection and generate a deformation, as shown in FIG. 10.

A driving unit 11 is disposed on a sidewall of the driving seat 1. A ball and socket unit 4 is deflectably connected to the driving unit 11. A steering ball unit 5 is rotatably connected to the other side of the ball and socket unit 4. Both a plurality of steering ball units 5 and a plurality of ball and socket units 4 are disposed. The steering ball units 5 and the ball and socket units 4 are alternately arranged.

An end of the ball and socket unit 4 is rotatably connected to an end seat unit 6. The elastic rod 2 penetrates the steering ball unit 5 and the ball and socket unit 4. A tail end of the elastic rod 2 is detachably mounted on the end seat unit 6.

A plurality of driving ropes 3 are fixedly connected to the end seat unit 6. The plurality of driving ropes 3 are generally arranged in a circumferential direction. All the plurality of driving ropes 3 penetrate the steering ball unit 5, the ball and socket unit 4, the driving unit 11, and the driving seat 1.

For the technical solution in this embodiment, the driving unit 11 includes a first cylindrical body 114 fixedly connected to a central position of the driving seat 1. The first cylindrical body 114 is hollow inside and is in communication with the first central hole 113. The first cylindrical body 114 and the driving seat 1 are integrally formed. The elastic rod 2 is arranged penetrating the first cylindrical body 114 and the first central hole 113.

A membrane balloon assembly 14 is sleeved over an outer surface of the first cylindrical body 114. The outer surface of the first cylindrical body 114 is slidably connected to a movable plate 15. The membrane balloon assembly 14 is located between the movable plate 15 and the driving seat 1. The movable plate 15 can slide in an axial direction of the first cylindrical body 114.

A first dome protrusion 151 is disposed on an outer side of the movable plate 15. An inner friction layer 16 and an outer friction layer 17 are fixedly connected to a sidewall of the movable plate 15. The inner friction layer 16 is located between the outer friction layer 17 and the first dome protrusion 151. The inner friction layer 16 and the outer friction layer 17 are both disposed in a spherical shape. Spherical centers of the inner friction layer 16, the outer friction layer 17, and the first dome protrusion 151 coincide.

As shown in FIG. 5 to FIG. 7, an inner unloading groove 162 is opened in a sidewall of the inner friction layer 16. An outer unloading groove 172 is opened in a sidewall of the outer friction layer 17. A cross spherical ring 18 is slidably connected to the sidewall of the outer friction layer 17. An inner slider 181 is fixedly connected to an inner spherical surface of the cross spherical ring 18. An outer slider 182 is fixedly connected to an outer spherical surface. Projections of the inner slider 181 and the outer slider 182 onto a plane formed by a ring of an end portion of the cross spherical ring 18 are perpendicular to each other. The cross spherical ring 18 is joined to an outer surface of the outer friction layer 17. An outer-layer sliding slot 171 matching the inner slider 181 is opened in an outer sidewall of the outer friction layer 17.

It needs to be noted that a pin hole is opened in the driving seat 1. A rotation-limiting pin 19 is fixedly connected in the pin hole. The other end of the rotation-limiting pin 19 is slidably connected in the movable plate 15. The rotation-limiting pin 19 is arranged penetrating the movable plate 15. When the movable plate 15 slides vertically along the first cylindrical body 114, the rotation-limiting pin 19 can provide limitation and guide for the movable plate 15 to keep the movable plate 15 from rotating.

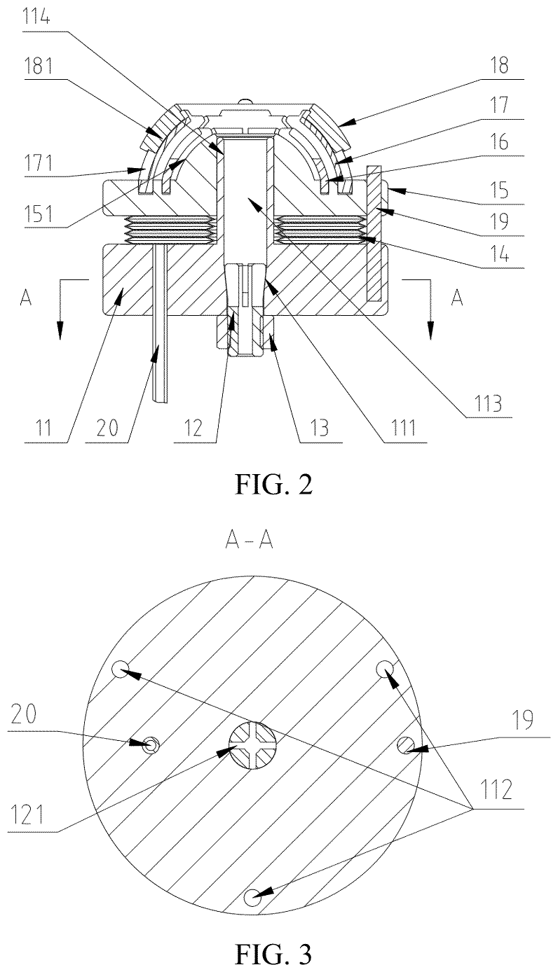

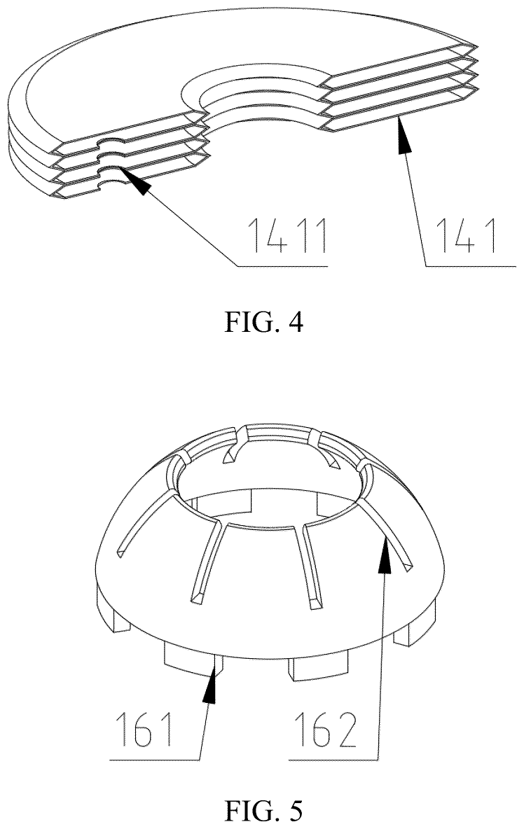

Further, as shown in FIG. 2 and FIG. 4, the membrane balloon assembly 14 is formed by superimposing a plurality of membrane balloons 141 and is generally disposed in a bellows shape. An air hole 1411 is opened inside each of the plurality of membrane balloons 141. Adjacent membrane balloons 141 are in communication with each other through the air holes 1411. An air pipe 20 is mounted penetrating the sidewall of the driving seat 1. The air pipe 20 is connected to and in communication with the air holes 1411. A compressed gas is introduced into the air pipe 20, and the membrane balloon assembly 14 is inflated to expand to compress the movable plate 15 to enable the movable plate 15 to slide in the axial direction of the first cylindrical body 114.

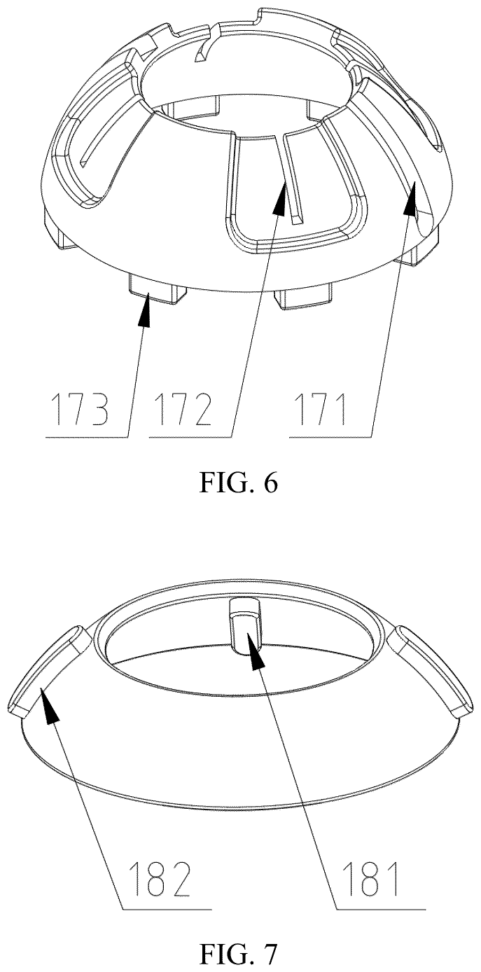

Further, as shown in FIG. 5 and FIG. 6, a plurality of inner-layer protrusions 161 are disposed at an end portion of the inner friction layer 16. A plurality of outer-layer protrusions 173 are disposed at an end portion of the outer friction layer 17. Recesses matching the inner-layer protrusions 161 and the outer-layer protrusions 173 are opened in the sidewall of the movable plate 15. The inner-layer protrusions 161 and the outer-layer protrusions 173 are inserted in the recesses, so that the inner friction layer 16 and the outer friction layer 17 can be fixed on the movable plate 15.

For the technical solution in this embodiment, as shown in FIG. 8 and FIG. 9, the ball and socket unit 4 includes a double ball and socket sleeve 41. A ball socket 411 is opened at each of two ends of the double ball and socket sleeve 41. A ball socket slot 412 is provided inside the ball socket 411.

A second central hole 413 is opened at a central position of the double ball and socket sleeve 41. The second central hole 413 and the ball socket slot 412 are in communication. Two guide rings 43 are symmetrically disposed at two ends of the second central hole 413. Both inner and outer surfaces of each guide ring 43 are concentric spherical surfaces. The two guide rings 43 are respectively concentric with the ball sockets 411 at the two ends of the double ball and socket sleeve 41.

A second cylindrical body 44 is fixedly connected to a sidewall of the guide ring 43. The second cylindrical body 44 is mounted in the second central hole 413 and can slide in the second central hole 413. The second cylindrical body 44 is hollow inside. The second cylindrical body 44 and the guide ring 43 are in communication. The second cylindrical body 44 and the guide ring 43 are integrally formed. The elastic rod 2 penetrates the second cylindrical body 44 and the second central hole 413.

An intermediate friction layer 42 is disposed between the ball socket 411 opened at each of the two ends of the double ball and socket sleeve 41 and the guide ring 43. Both inner and outer surfaces of the intermediate friction layer 42 are concentric spherical surfaces. The intermediate friction layer 42 is concentric with the ball socket 411. The intermediate friction layer 42 is sleeved over the second cylindrical body 44.

Specifically, when the driving unit 11 is rotatably connected to the ball and socket unit 4, the first dome protrusion 151 on an end surface of the movable plate 15, the guide ring 43, the inner friction layer 16, the intermediate friction layer 42, the outer friction layer 17, and the cross spherical ring 18 are sequentially connected and concentrically arranged. The outer slider 182 on an outer side of the cross spherical ring 18 in the driving unit 11 is inserted in the ball socket slot 412 of the double ball and socket sleeve 41. In this case, the guide ring 43 can slide relatively between the first dome protrusion 151 and the inner friction layer 16. The intermediate friction layer 42 can slide relatively between the inner friction layer 16 and the outer friction layer 17. The outer slider 182 can slide relatively along the ball socket slot 412. In this way, the ball and socket unit 4 can deflect around the driving unit 11 to implement steering. In addition, through the coordination among the inner slider 181, the outer slider 182, the outer-layer sliding slot 171, and the ball socket slot 412, the torsion between the driving unit 11 and the ball and socket unit 4 can be further restricted, to keep the freedom of torsion of t he driving unit 11 and the ball and socket unit 4 from becoming excessively large.

For the technical solution in this embodiment, as shown in FIG. 10, the steering ball unit 5 includes a joint ball 51. Two second dome protrusions 511 are disposed on two sides of the joint ball 51. The two second dome protrusions 511 are concentric. A guide hole 512 is opened at a top end of each of the two second dome protrusions 511. The elastic rod 2 penetrates the guide holes 512 of the joint ball 51.

The inner friction layer 16 and the outer friction layer 17 are respectively fixedly connected to the two sides of the joint ball 51. The inner friction layer 16 is located between the outer friction layer 17 and the second dome protrusion 511. The inner friction layer 16, the outer friction layer 17, and the second dome protrusion 511 are concentrically arranged.

The cross spherical ring 18 is also slidably connected to the outer sidewall of the outer friction layer 17. The inner slider 181 and the outer slider 182 are respectively fixedly connected on the inner and outer spherical surfaces of the cross spherical ring 18.

It needs to be noted that manner of fixing the inner friction layer 16 and the outer friction layer 17 to the joint ball 51 is the same as that to the movable plate 15.

Specifically, when the steering ball unit 5 is rotatably connected to an adjacent ball and socket unit 4. The second dome protrusion 511 on the joint ball 51, the guide ring 43, the inner friction layer 16, the intermediate friction layer 42, the outer friction layer 17, and the cross spherical ring 18 are sequentially connected and concentrically arranged. The outer slider 182 on the outer side of the cross spherical ring 18 in the steering ball unit 5 is inserted in the ball socket slot 412 of the double ball and socket sleeve 41. In this case, the guide ring 43 can slide relatively between the second dome protrusion 511 and the inner friction layer 16. The intermediate friction layer 42 can slide relatively between the inner friction layer 16 and the outer friction layer 17. The outer slider 182 can slide relatively along the ball socket slot 412. In this way, the steering ball unit 5 can deflect around the ball and socket unit 4 to implement steering. In addition, through the coordination among the inner slider 181, the outer slider 182, the outer-layer sliding slot 171, and the ball socket slot 412, the torsion between the steering ball unit 5 and the ball and socket unit 4 can be further restricted, to keep the freedom of torsion of the steering ball unit 5 and the ball and socket unit 4 from becoming excessively large.

For the technical solution in this embodiment, as shown in FIG. 11, the end seat unit 6 includes an end plate 61 fixed at an end of each driving rope 3. An end dome 62 is fixedly connected to a sidewall of the end plate 61. A third central hole 611 is opened at central positions of the end plate 61 and the end dome 62. The spring chuck 12 is mounted in the third central hole 611. A second tapered surface 612 matching the tapered portion 122 of the spring chuck 12 is disposed in the third central hole 611. The tail end of the elastic rod 2 is connected in the spring chuck 12.

The end of the spring chuck 12 away from the tapered portion 122 is threadedly connected to the locking nut 13. The locking nut 13 is located in the third central hole 611 of the end dome 62. Under the limitation of the second tapered surface 612, the locking nut 13 is tightened to drive the tapered portion 122 of the spring chuck 12 to make the tapered portion 122 of the spring chuck 12 deform to fix the tail end of the elastic rod 2 on the spring chuck 12, so that the tail end of the elastic rod 2 is fixed on the end plate 61.

The inner friction layer 16 and the outer friction layer 17 are fixedly connected to the sidewall of the end plate 61. The inner friction layer 16 is located between the outer friction layer 17 and the end dome 62. The inner friction layer 16, the outer friction layer 17, and the end dome 62 are concentrically arranged.

The cross spherical ring 18 is also slidably connected to the outer sidewall of the outer friction layer 17. The inner slider 181 and the outer slider 182 are respectively fixedly connected on the inner and outer spherical surfaces of the cross spherical ring 18.

Specifically, when the end seat unit 6 is rotatably connected to an adjacent ball and socket unit 4, the end dome 62, the guide ring 43, the inner friction layer 16, the intermediate friction layer 42, the outer friction layer 17, and the cross spherical ring 18 are sequentially connected and concentrically arranged. The outer slider 182 on the outer side of the cross spherical ring 18 in the end seat unit 6 is inserted in the ball socket slot 412 of the double ball and socket sleeve 41. In this case, the guide ring 43 can slide relatively between the end dome 62 and the inner friction layer 16. The intermediate friction layer 42 can slide relatively between the inner friction layer 16 and the outer friction layer 17. The outer slider 182 can slide relatively along the ball socket slot 412. In this way, the end seat unit 6 can deflect around the ball and socket unit 4 to implement steering. In addition, through the coordination among the inner slider 181, the outer slider 182, the outer-layer sliding slot 171, and the ball socket slot 412, the torsion between the end seat unit 6 and the ball and socket unit 4 can be restricted, to keep the freedom of torsion of the end seat unit 6 and the ball and socket unit 4 from becoming excessively large.

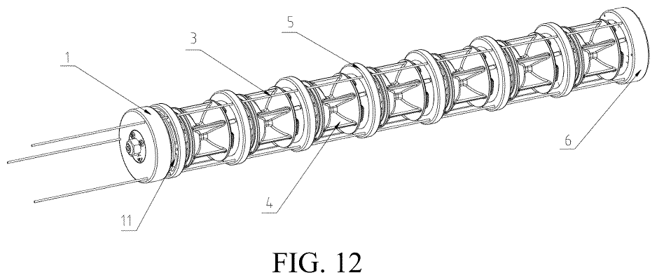

For the technical solution in this embodiment, as shown in FIG. 12, three driving ropes 3 are disposed. The three driving ropes 3 are all fixed on the end plate 61 of the end seat unit 6. The three driving ropes 3 are arranged in a circumferential direction of the end plate 61, and adjacent driving ropes 3 have equal intervals. The through holes 112 for the driving ropes 3 to pass through are provided in a sidewall of the joint ball 51 and the sidewall of the driving seat 1. It needs to be noted that free ends of the driving ropes 3 passing through the position of the driving seat 1 are connected to an external traction equipment. The traction equipment may be disposed as a hydraulic rod, a tractor, or the like, is not limited herein, and may be selected according to an actual case.

A use method and procedure of the present invention:

As shown in FIG. 12, when bending is required, the external traction equipment pulls the driving rope 3 in a to-be-pulled direction, and appropriately loosens the remaining driving ropes 3, to avoid interference. In this case, the driving ropes 3 generate unequal displacements, so that the end plate 61, the steering ball unit 5, and the ball and socket unit 4 generate relative rotations, to implement the overall bending of the robot, thereby implementing functions such as steering and obstacle avoidance.

When no compressed gas is filled inside the membrane balloons 141, the movable plate 15 can freely slide in the axial direction of the first cylindrical body 114. In this case, the robot is in a flexible state, and can bend freely. When the overall rigidity of the robot needs to be adjusted, a compressed gas is first introduced into the air pipe 20 through an external air pump, and the membrane balloon assembly 14 is inflated to expand to compress the movable plate 15 to enable the movable plate 15 to slide in the axial direction of the first cylindrical body 114. The two ends of the elastic rod 2 are respectively fixed on the end plate 61 and the driving seat 1. Therefore, the total length of the robot is constrained. In this case, after sliding, the movable plate 15 first compresses the ball and socket unit 4, and the ball and socket unit 4 compresses the steering ball unit and the end plate 61, to enable structures such as the inner friction layer 16, the intermediate friction layer 42, the outer friction layer 17, and the cross spherical ring 18 between the units to be tightly compressed to form a whole, thereby increasing t he frictional forces between the units. In this case, the entire robot is changed from a flexible state into a rigid state, and the frictional forces between the units can be controlled by adjusting an inflation size of the membrane balloon assembly 14, so that the rigidity of the robot can be controlled, to facilitate the adaptive adjustment of the use rigidity of the robot according to an actual case, thereby improving the practicability.

It needs to be noted that the relational terms herein such as first and second are used only to differentiate an entity or operation from another entity or operation, and do not require or imply any actual relationship or sequence between these entities or operations. Moreover, the terms “include,” “comprise,” and any variation thereof are intended to cover a non-exclusive inclusion. Therefore, in the context of a process, a method, an object, or a device that includes a series of elements, the process, method, object, or device not only includes such elements, but also includes other elements not specified expressly, or may include inherent elements of the process, method, object, or device.

A person of ordinary skill in the art may understand the specific meanings of the foregoing terms in the present invention according to specific situations. When an element is referred to as being “assembled on”, “mounted on”, “fixed on”, or “disposed on” another element, it may be directly on the other element or there may be an intervening element. When an element is considered to be “connected” to another element, it may be directly connected to the other element or there may be an intervening element. The terms “vertical”, “horizontal”, “upper”, “lower”, “left”, “right”, and similar expressions used herein are merely intended for description, and do not indicate a unique implementation.

Although the embodiments of the present invention are already shown and described, a person of ordinary skill in the art may understand that various changes, modifications, replacements and variations may be made to the embodiments without departing from the principles and spirit of the present invention, and the scope of the present invention is as defined by the appended claims and their equivalents.

In the descriptions of this specification, a description of a reference term such as “an embodiment”, “an example”, or “a specific example” means that a specific feature, structure, material, or characteristic that is described with reference to the embodiment or the example is included in at least one embodiment or example of the present disclosure. In this specification, exemplary descriptions of the foregoing terms do not necessarily refer to the same embodiment or example. In addition, the described specific features, structures, materials, or characteristics may be combined in a proper manner in any one or more of the embodiments or examples.

1. A variable-rigidity continuum robot, comprising a driving seat (1), wherein a first central hole (113) is opened at a center of the driving seat (1), a spring chuck (12) is mounted inside the first central hole (113), a tapered portion (122) is disposed at a top of the spring chuck (12), a notch (121) is opened in a sidewall of the tapered portion (122), and a first tapered surface (111) matching the tapered portion (122) is disposed on an inner sidewall of the first central hole (113) close to a bottom;
an elastic rod (2) is detachably mounted on the spring chuck (12), and an end of the spring chuck (12) away from the tapered portion (122) extends out of an end portion of the driving seat (1) and is threadedly connected to a locking nut (13);
a driving unit (11) is disposed on a sidewall of the driving seat (1), a ball and socket unit (4) is deflectably connected to the driving unit (11), a steering ball unit (5) is rotatably connected to the other side of the ball and socket unit (4), both a plurality of steering ball units (5) and a plurality of ball and socket units (4) are disposed, and the steering ball units (5) and the ball and socket units (4) are alternately arranged;
an end of the ball and socket unit (4) is rotatably connected to an end seat unit (6), the elastic rod (2) penetrates the steering ball unit (5) and the ball and socket unit (4), and a tail end of the elastic rod (2) is detachably mounted on the end seat unit (6); and
a plurality of driving ropes (3) are fixedly connected to the end seat unit (6), the plurality of driving ropes (3) are generally arranged in a circumferential direction, and all the plurality of driving ropes (3) penetrate the steering ball unit (5), the driving unit (11), and the driving seat (1).

2. The variable-rigidity continuum robot according to claim 1, wherein the driving unit (11) comprises a first cylindrical body (114) fixedly connected to a central position of the driving seat (1), the first cylindrical body (114) is hollow inside and is in communication with the first central hole (113), and the elastic rod (2) is arranged penetrating the first cylindrical body (114) and the first central hole (113);
a membrane balloon (141) assembly (14) is sleeved over an outer surface of the first cylindrical body (114), the outer surface of the first cylindrical body (114) is slidably connected to a movable plate (15), and the membrane balloon (141) assembly (14) is located between the movable plate (15) and the driving seat (1);
a first dome protrusion (151) is disposed on an outer side of the movable plate (15), an inner friction layer (16) and an outer friction layer (17) are fixedly connected to a sidewall of the movable plate (15), the inner friction layer (16) is located between the outer friction layer (17) and the first dome protrusion (151), the inner friction layer (16) and the outer friction layer

(17) are both disposed in a spherical shape, and spherical centers of the inner friction layer (16), the outer friction layer (17), and the first dome protrusion (151) coincide; and
an inner unloading groove (162) is opened in a sidewall of the inner friction layer (16), an outer unloading groove (172) is opened in a sidewall of the outer friction layer (17), a cross spherical ring (18) is slidably connected to the sidewall of the outer friction layer (17), an inner slider (181) is fixedly connected to an inner spherical surface of the cross spherical ring (18), an outer slider (182) is fixedly connected to an outer spherical surface, the cross spherical ring (18) is joined to an outer surface of the outer friction layer (17), and an outer-layer sliding slot (171) matching the inner slider (181) is opened in an outer sidewall of the outer friction layer (17).

3. The variable-rigidity continuum robot according to claim 2, wherein the membrane balloon (141) assembly (14) is formed by superimposing a plurality of membrane balloons (141) and is generally disposed in a bellows shape, an air hole (1411) is opened inside each of the plurality of membrane balloons (141), adjacent membrane balloons (141) are in communication with each other through the air holes (1411), an air pipe (20) is mounted penetrating the sidewall of the driving seat (1), and the air pipe (20) is connected to and in communication with the air holes (1411).

4. The variable-rigidity continuum robot according to claim 2, wherein the ball and socket unit (4) comprises a double ball and socket sleeve (41), a ball socket (411) is opened at each of two ends of the double ball and socket sleeve (41), and a ball socket slot (412) is provided inside the ball socket (411);
a second central hole (413) is opened at a central position of the double ball and socket sleeve (41), two guide rings (43) are symmetrically disposed at two ends of the second central hole (413), both inner and outer surfaces of each guide ring (43) are concentric spherical surfaces, and the two guide rings (43) are respectively concentric with the ball sockets (411) at the two ends of the double ball and socket sleeve (41);
a second cylindrical body (44) is fixedly connected to a sidewall of the guide ring (43), the second cylindrical body (44) is mounted in the second central hole (413), the second cylindrical body (44) is hollow inside, the second cylindrical body and the guide ring (43) are in communication, and the elastic rod (2) penetrates the second cylindrical body (44) and the second central hole (413); and
an intermediate friction layer (42) is disposed between the ball socket (411) opened at each of the two ends of the double ball and socket sleeve (41) and the guide ring (43), both inner and outer surfaces of the intermediate friction layer (42) are concentric spherical surfaces, t he intermediate friction layer (42) is concentric with the ball socket (411), and the intermediate friction layer (42) is sleeved over the second cylindrical body (44).

5. The variable-rigidity continuum robot according to claim 4, wherein when the driving unit (11) is rotatably connected to the ball and socket unit (4), the first dome protrusion (151) on an end surface of the movable plate (15), the guide ring (43), the inner friction layer (16), the intermediate friction layer (42), the outer friction layer (17), and the cross spherical ring (18) are sequentially connected and concentrically arranged; and
the outer slider (182) on an outer side of the cross spherical ring (18) in the driving unit (11) is inserted in the ball socket slot (412) of the double ball and socket sleeve (41) and slides along the ball socket slot (412).

6. The variable-rigidity continuum robot according to claim 5, wherein the steering ball unit (5) comprises a joint ball (51), two second dome protrusions (511) are disposed on two sides of the joint ball (51), the two second dome protrusions (511) are concentric, a guide hole (512) is opened at a top end of each of the two second dome protrusions (511), and the elastic rod (2) penetrates the guide holes (512) of the joint ball (51);
the inner friction layer (16) and the outer friction layer (17) are respectively fixedly connected to the two sides of the joint ball (51), the inner friction layer (16) is located between the outer friction layer (17) and the second dome protrusion (511), and the inner friction layer (16), the outer friction layer (17), and the second dome protrusion (511) are concentrically arranged; and
the cross spherical ring (18) is also slidably connected to the outer sidewall of the outer friction layer (17).

7. The variable-rigidity continuum robot according to claim 6, wherein when the steering ball unit (5) is rotatably connected to an adjacent ball and socket unit (4), the second dome protrusion (511) on the joint ball (51), the guide ring (43), the inner friction layer (16), the intermediate friction layer (42), the outer friction layer (17), and the cross spherical ring (18) are sequentially connected and concentrically arranged; and
the outer slider (182) on the outer side of the cross spherical ring (18) in the steering ball unit (5) is inserted in the ball socket slot (412) of the double ball and socket sleeve (41) and is slidable along the ball socket slot (412).

8. The variable-rigidity continuum robot according to claim 7, wherein the end seat unit (6) comprises an end plate (61) fixed at an end of each driving rope (3), an end dome (62) is fixedly connected to a sidewall of the end plate (61), a third central hole (611) is opened at central positions of the end plate (61) and the end dome (62), the spring chuck (12) is mounted in the third central hole (611), a second tapered surface (612) matching the tapered portion

(122) of the spring chuck (12) is disposed in the third central hole (611), and the tail end of the elastic rod (2) is connected in the spring chuck (12);
the end of the spring chuck (12) away from the tapered portion (122) is threadedly connected to the locking nut (13), and the locking nut (13) is located in the third central hole (611) of the end dome (62);
the inner friction layer (16) and the outer friction layer (17) are fixedly connected to the sidewall of the end plate (61), the inner friction layer (16) is located between the outer friction layer (17) and the end dome (62), and the inner friction layer (16), the outer friction layer (17), and the end dome (62) are concentrically arranged; and
the cross spherical ring (18) is also slidably connected to the outer sidewall of the outer friction layer (17).

9. The variable-rigidity continuum robot according to claim 8, wherein when the end seat unit (6) is rotatably connected to an adjacent ball and socket unit (4), the end dome (62), the guide ring (43), the inner friction layer (16), the intermediate friction layer (42), the outer friction layer (17), and the cross spherical ring (18) are sequentially connected and concentrically arranged; and
the outer slider (182) on the outer side of the cross spherical ring (18) in the end seat unit (6) is inserted in the ball socket slot (412) of the double ball and socket sleeve (41) and is slidable along the ball socket slot (412).

10. The variable-rigidity continuum robot according to claim 9, wherein a pin hole is opened in the driving seat (1), a rotation-limiting pin (19) is fixedly connected in the pin hole, and the other end of the rotation-limiting pin (19) is slidably connected in the movable plate (15).
